(19) United States
(12) Patent Application Publication
(10) Pub. No.: US 2019/0274248 A1
(43) Pub. Date: Sep. 12, 2019

(54) HARVESTING DEVICE

(71) Applicant: MOSMAN MACHINERY COMPANY, INC., Nevada City, CA (US)

(72) Inventors: DANA ELIOT MOSMAN, BOULDER, CO (US); DONALD MOSMAN, NEVADA CITY, CA (US); ANGEL RAMON TORRADO PEREZ, LAKEWOOD, CO (US)

(21) Appl. No.: 16/296,989

(22) Filed: Mar. 8, 2019

Related U.S. Application Data
(60) Provisional application No. 62/640,247, filed on Mar. 8, 2018.

(51) Int. Cl. A01D 46/00

(52) U.S. Cl. CPC A01D 46/00

(57) ABSTRACT

The present invention shows an apparatus for trimming plants, specifically assisting with the process of separating leaves and buds from the stem and branches of the plant. The apparatus is composed by a shearing device including an outer hub with at least one recess located in a first end of the outer hub and an inner shear surface. The apparatus also includes an inner cutting member having a shearing element, an outer surface and a feed aperture extending along a longitudinal axis of the inner cutting member. The inner cutting member is concentrically disposed within the outer hub such that the shearing element at least partially overlaps the at least one recess. Further included is a cutting driver configured to rotate the inner cutting member. The shearing device and cutting driver are mounted on a feed plate that can removably couple to a harvesting device.

### CROSS REFERENCE

This application claims the benefit of the filing date of U.S. Provisional Application No. 62/640,247 filed on Mar. 8, 2018 the entire contents of which is incorporated herein by reference.

### FIELD

The present disclosure is directed to the trimming of plants, and in particular to the removing of material such a leaves, buds and flowers from a stem portion of a plant.

### BACKGROUND

Flowers, buds and leaves harvested from stemmed plants are often used in oils, medicinal products, aromatherapy, cuisine, perfumes, dyes, toilet preparations, tinctures, distillation products (steam distillation of lavender oil), and the like. Such stemmed plants are sometimes cut at the base of the stem (e.g., trunk, stalk, etc.) in the field and transported to a location for processing.

Commonly, such processing requires numerous workers who manually strip useful portions of the plant (leaves, buds, etc.) from the generally less useful stem portion(s). This processing may be labor intensive, repetitive and time-consuming. In addition, it is not appealing to many workers. Machines can be used to perform limited aspects of these tasks. For instance, bucking machines are used to separate flowers/buds from individual branches of a plant. That is after a plant is harvested and branches are removed from the main stem by hand, such as by workers individually cutting each branch off the stem. Then, individual branches can be fed into a bucking machine to remove any flowers and/or buds attached thereto. A common bucking machine includes a front plate with an aperture and a pair of drums or feed wheels located behind the plate. A branch of a plant is inserted through the aperture to engage with the drive wheels. Then, as the drive wheels pull the branch through the aperture, buds and/or flowers are forced off the branch. Specifically, the aperture is sized to allow the branch to pass through the plate but is small enough such that the flowers/buds collide with the front of the plate and are ripped from the branch.

Traditional bucking machines are limited in multiple ways. For example, if a branch or stem is too large, the wheels may not have enough grip to pull the branch through the aperture because the size of other branches and/or flowers/buds creates too much resistance. In this regard, significant manual labor is needed to cut and prune stems and branches to the appropriate size.

Further, the process of pulling the flowers/buds into the front of the plate causes the flower/buds to be ripped from the branch. The force from these collisions and ripping can damage desirable portions of the flowers/buds thereby decreasing their usefulness and value in the market. What is recognized from these drawbacks is that simple pulling and ripping of flowers and/or buds from a branch is not ideal and presents drawbacks—most notably, simple pulling is limited to a narrow range of sizes of plant stems/branches and can bruise the desirable flowers/buds thereby decreasing their value.

### SUMMARY

Aspects of the presented disclosure are directed to a harvesting device that strips material of a plant from a stem portion of a plant. One aspect s directed to a shearing mechanism including a hollow rotating cutting member through which a stalk or stem of a plant passes. In an embodiment, the shearing mechanism includes an outer hub and an inner cutting member. The outer hub extends along a longitudinal axis and the inner cutting member is concentrically disposed within the outer hub. In any embodiment, the inner cutting member can define a feed aperture (e.g., hollow interior) through which a plant stalk or stem pay pass. The harvesting device further includes a cutting drive interconnected with the cutting member. The cutting drive is configured to rotate the cutting member about a longitudinal axis that extends through the hollow interior of the cutting member. The cutting drive may be an independent actuator (e.g., electric motor) or may be a drive system that operates from a separate source (e.g., power take off). The harvesting device can also include a feed drive. The feed drive includes a first electric motor, a first drive roller and a second drive roller. The first drive roller and/or the second drive roller can be rotationally powered by the first electric motor. Alternatively, friction between the rollers may allow one roller to drive the other roller. Further, each roller may be independently driven by a separate electric motor. In one arrangement, one of the drive rollers forms a portion of the cutting drive. The first and second drive rollers are configured to receive and engage a stem or a plant to pull the stem or plant through the feed aperture. Some embodiments include a shear element extending from a first end of the cutting member. Other embodiments include a forward edge of the cutting member including a cutting edge (e.g., serrations). In an embodiment including the outer hub, a front end of the outer hub can also include a series of recesses in which a shear element of the cutting member at least partially overlaps. Further, embodiments include disposing the shear element to be concentrically disposed within the series of recesses such that the shear element is configured to rotate along an inner surface of the outer hub.

The harvesting device can also include an engagement lever interconnected to a drive roller. In an engaged configuration the engagement lever positions an outer surface of the drive roller in contact with a portion of an outer surface of an opposing drive roller. In a disengaged configuration the engagement lever positions the second outer surfaces of the roller at a spaced distance from one another.

The harvesting device may also have a housing including a front plate, a plurality of walls extending from the front plate (e.g., rearward) to form an enclosure around at least a portion of the feed drive. Embodiments also include a first implement adapter that operated to removably, interconnect the shearing mechanism and to the front plate. The harvesting device may include a second implement adapter configured to removably connect a second feed plate to the harvesting device. Embodiments include multiple feed drives such as a second feed drive having a third drive roller rotationally powered by the first electric motor and a fourth drive roller, where the third and fourth drive roller are configured to receive a plant and/or stem to pull the plant/stem through a second feed aperture associated with the second implement adapter. In another aspect, shearing devices may be modular to interchangeably connect and disconnect from the harvesting device.

Aspects include a method of removing plant material form a stem and branches of a plant. The method includes receiving a first portion of a plant in a first feed drive of a harvesting device, rotating a first drive roller of a drive mechanism to engage the first portion of the plant and pull the plant through the harvesting device, and rotating a first cutting member defining a feed aperture to cut a portion of the plant from a stem or stalk of the plant as the drive mechanism pulls the first portion of the plant through the feed aperture. Implementations of the method include selecting a rotating speed of the first cutting member based on a rate of rotation of the first drive roller.

### BRIEF DESCRIPTION OF THE DRAWINGS

FIGS. 1A and 1B illustrate front and back perspective views, respectively, of embodiments of a harvesting device in accordance with the presented inventions.

FIGS. 2A and 2B illustrate side views of embodiments of a feed module of the harvesting device.

FIGS. 3A and 3B illustrate front and back perspective views, respectively, of embodiments of a feed plate of the harvesting device.

FIG. 3C illustrates a back-perspective view of an alternate embodiment of a feed plate drive mechanism.

FIG. 3D illustrates a front perspective view of an alternate embodiment of a feed plate of the harvesting device.

FIGS. 4A and 4B illustrate side cut-away views taken at different cross section of embodiments of the harvesting device.

FIGS. 5A and 5B illustrate side views of an embodiment of an engagement lever of the harvesting device.

FIG. 6 illustrates a side view of embodiments of a feed module of a harvesting device processing a plant.

FIG. 7 is a flow chart of a method of operating a harvesting device.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

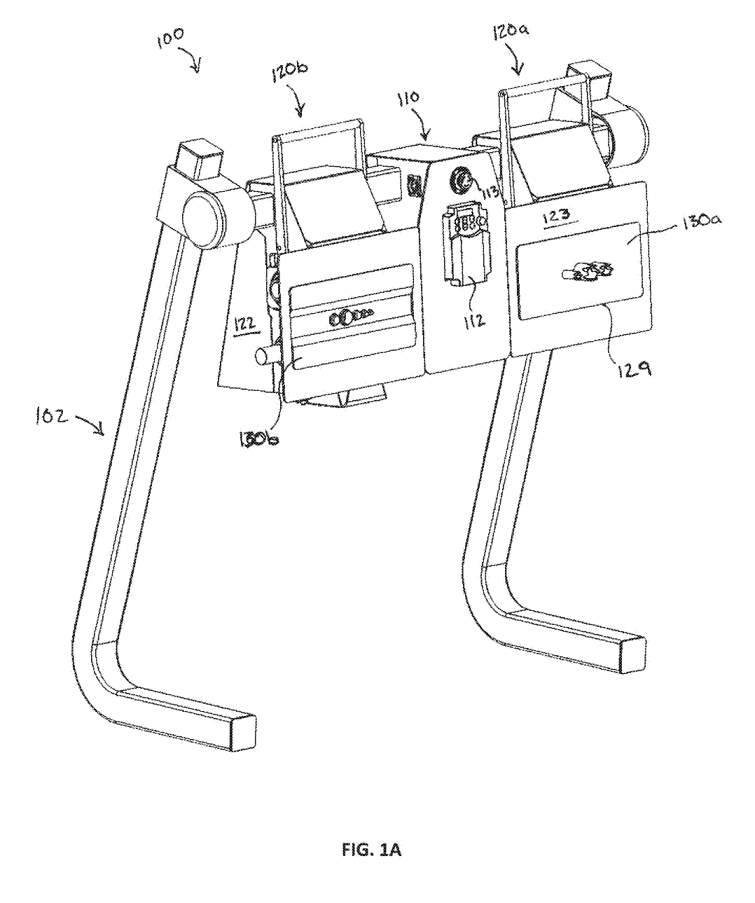

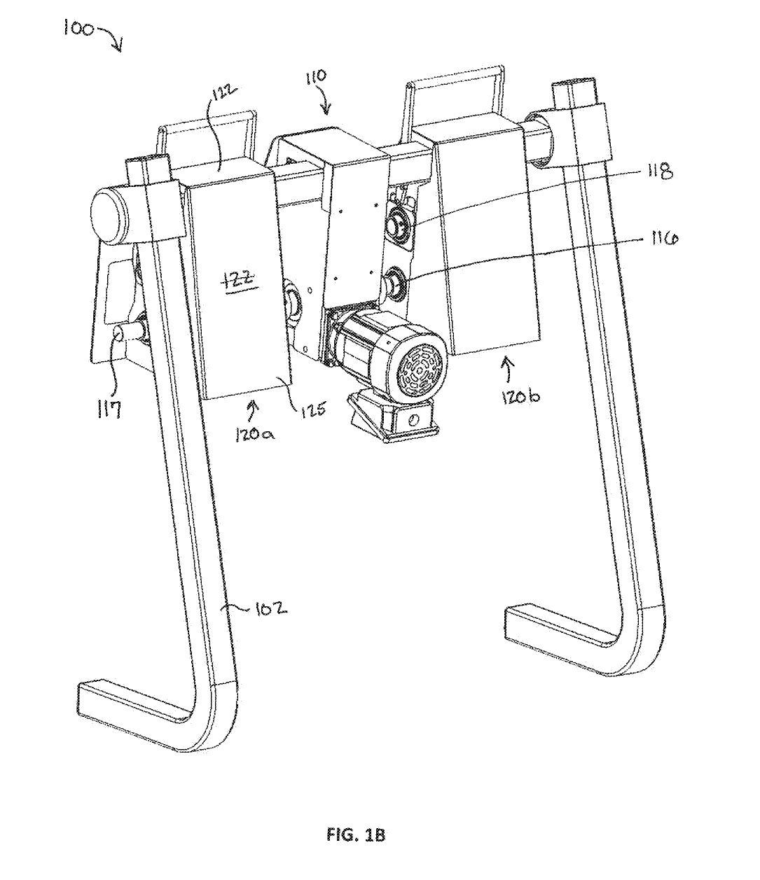

The presented device or machine is directed to removing plant material (e.g., buds, leaves, etc.) from the stem and branches of a plant. FIGS. 1A and 1B provide front and back perspective views, respectively, of harvesting device 100 including major components of a power drive 110 and feed modules 120a, 120b. The power drive 110 drives feed modules 120, which process plants to separate various parts of the plant (e.g., stem, branches, flowers, leaves, buds, etc.) from each other. For example, the feed module can be configured to separate buds from branches of a plant.

The power drive 110 is disposed within a housing and can independently couple to a first feed module 120a and a second feed module 120b. In the illustrated embodiment, two feed modules 120 are shown, but additional feed modules can be connected to the power drive 110. The feed modules 120 are each disposed within a housing 122, which can be constructed of any appropriate material(s) such as aluminum, steel, hard plastic, etc. and may be configured to shield users from debris and moving parts. The housing 122 includes a front plate 123 and a back plate 125. The harvesting device 100 further includes feed plates 130a and 130b (hereinafter 130 unless specifically referenced) attached to the front plate 123 of the housing 122. The feed plates 120 can be removably attached to front plate 123 such that they can be connected and disconnected from the front plate 123. In this regard, a common feed plate 130 can be used to connect different harvesting components to the front plate 123 of the harvesting device 100. For example, feed plate 130a having a first functionality (e.g., including rotating components to shear portions of the plant), can be connected to the first feed module 120a, and feed plate 130b having a second functionality (e.g., including static components that remove plant material such as buds from a smaller stem) can be connected to the second feed module 120b.

In some embodiments, front plate 123 can include an implement adapter 129 for removably interconnecting feed plate 130. Implement adapter 129 can be an aperture in front plate 123 sized to accept and position feed plate 130 in a relative alignment with the feed module 120. Implement adapter 129 can include fasteners for coupling feed plate 130 to front plate 123. For example, threaded knobs can be used to quickly attach and detach feed plate 130 to the harvesting device 100. In this regard, feed plates can easily be attached and removed for tasks such as cleaning, maintenance, and/or to attach a differently configured feed plate 130 (e.g., for processing larger plants, different shearing mechanism as discussed below, etc.).

The power drive 110 and feed modules 120 are mounted on a stand 102, which suspends the power drive 110 and feed modules above the ground. In this regard, collection bins, carts, and/or the like can be located in the space below the feed modules 120 to collect plant material and/or stems, branches and other parts of the plant and/or processing by-products. In some embodiments, the back plate 125 of the housing can be constructed to divert plant material and/or stems that pass through the feed plates 130 downward. Such a configuration of the back plate can facilitate diverting plant material into collection bins, disposal bins, carts and/or the like. Further, the back plate 125 can be angled or have an exit port (not shown) to facilitate separation of different parts of the plant. For example, a plant branch containing plant material can be passed through the front plate 130, and the front plate can remove (e.g., strip, shear, cut and/or the like) the plant material from the stem. In this embodiment, the plant material can be collected at a bin located at or below the front plate 130. Additionally, the stem may be diverted by the back plate 125 into a separate bin. As such, processing of a plant stem can through the harvesting device can also result in the different portion of the plant being diverted and/or collected in different containers.

In some embodiments, additional feed modules 120 can be mounted to the stand 102 to allow for additional processing stations. Additional feed modules can be used to increase harvesting/processing throughput, allow for additional feed plates 130 with other functionalities (e.g., feed plates 130 that can process larger or smaller plants) and/or the like. In this regard, the harvesting device 100 can be configured in multiple different embodiments to varying needs of different users (e.g., higher throughput, different feed plate functionalities, etc.).

The front plate 123 is preferably constructed from a hard metal such as steel to resist damage from repeated impact and scraping from branches, stems, etc. Notably, although illustrated as a flat rectangular shape, it should be appreciated that the front plate 123 may be of any appropriate size and shape and is configured to accommodate feed plates 130. For example, the front plate 123 can be configured to accept feed plates 130 of different shapes (e.g., square, circular, etc.), sizes, and functionalities (described in greater detail below). In some embodiments, the front plate 123 can include fastening and/or diverting components for facilitating collection and processing of plant material. For example, the front plate 123 can include a hanger for disposing a collection bin directly below the feed plate 130. In this regard, plant material separated from a stem/branch can be collected in the collection bin (or other container, conveyer belt and/or the like) at or adjacent to the feed plate 130. Such a configuration can facilitate automation and throughput of the plant harvesting device 100. In other arrangements, collection components such as bins and containers can be disposed on and/or integrated into the feed plate 130. For example, the feed plate 130 can include a chute/ramp to divert plant material away from the front plate 123 and towards, for example, a collection bin located in front of the harvesting device 100.

Embodiments of power drive 110 include a control unit 112 and a motor 114. The control unit 112 can include any number of operational control and feedback devices. In the illustrated embodiment, control unit 112 includes a display (e.g., LCD), an emergency shutoff switch 113, a speed inversion switch, a power switch, and a speed selector knob. The display may provide a user with visual feedback including, but not limited to, current operating speed, current blade or drive roller pressure, motor temperature, total hours of use, detected anomalies or maintenance issues, battery indicator, etc. Speed inversion switch may be manipulated by a user to adjust the operating direction of the harvesting device 100. More specifically, the speed inversion switch may adjust the operating direction of one or more drive motors (described in more detail below), as may be necessary to unjam a plant stuck in the drive mechanism. The power switch may be any appropriate mechanism effective for powering on and off the harvesting device 100. Emergency shutoff switch 113 may be provided as a secondary means (in addition to the power switch) for quickly disengaging the drive motors of the drive mechanism. The speed selector knob may be manipulated to adjust the rotational speed of one or more drive motors 114 used to pull a plant stem through the harvesting device 100, thereby affecting the speed at which plants are fed through the harvesting device 100. It should be appreciated that the illustrated embodiment of control unit 112 is provided for example only. Each depicted switch, button, or knob may be optional, and the arrangement of controls may be altered. For example, it may be desirable to locate emergency shutoff switch 113 on a rear panel of the power drive 110 or at another location remote from the power switch to provide a user with multiple options for shutting down the device in an emergency. Although not shown, in some embodiments a pressure selector knob may be provided to adjust one or more settings of a sensor (e.g., sensitivity) disposed within the harvesting device 100 used for monitoring the positioning a component. For example, as discussed below, the positioning of a drive roller of the drive mechanism may be adjustable to increase or decrease pressure exerted on the stem of a plant. This may be useful, for example, to ensure a sufficient grip on the stem to efficiently move the plant through the harvesting device 100 without exerting too much pressure which may crush the stem creating debris or causing the drive mechanism to jam. The motor 114 can be an electric motor powered by wired electricity and/or battery powered. In some embodiments, power drive 110 could be powered by a generator and/or be configured to receive power from other equipment such as a hydraulic drive common on farm machinery (e.g., skid steer, tractor, and/or the like).

The harvesting device 100 can also include couplings 116 for interconnecting the power drive 110 to the feed modules 120. In the illustrated embodiment, flexible rotational couplings 116 are used to rotationally couple the motor 114 to each feed module 120. Although not illustrated, additional feed modules 120 can be connected to the motor 114 through additional coupling(s) connected to axle(s) 117. That is, additional feed modules 120 can be linearly disposed along the stand 102 and receive power through axle(s) 117 coupled to either side of the motor 114. In this regard, harvesting devices 100 can include configurations that have multiple feed modules disposed in a series on a first side of the power drive 110, on a second side of the power drive 110, and/or have differing numbers of feed modules 120 disposed on each side of the power drive. That is, there does not have to be an equal number of feed modules 120 on each side of the power drive 110. In some embodiments, multiple power drives 110 can be disposed on a single stand. For example, a certain feed module and/or feed plate can be configured for processing larger stems and/or branches. In this instance, a single motor 114 can be dedicated to one feed module 120, while a second motor can be coupled to additional feed modules mounted on the stand 102.

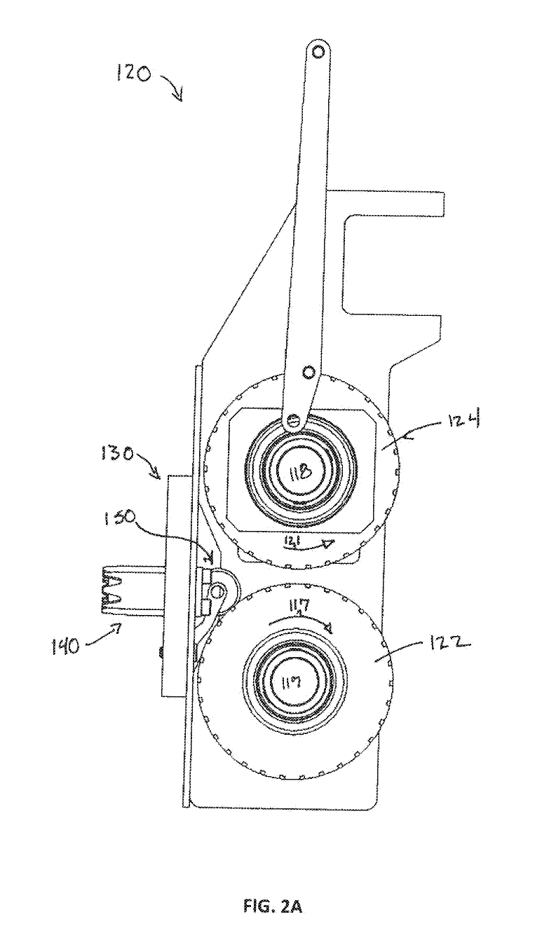

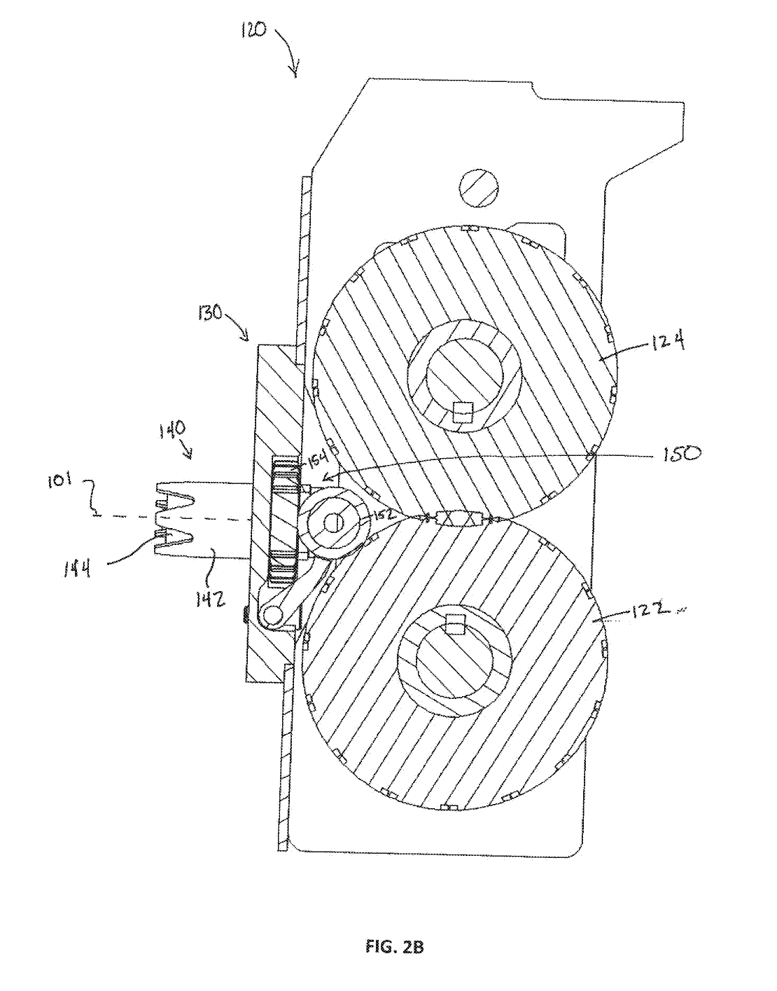

FIGS. 2A and 2B illustrate side views of embodiments of the feed module 120 of the harvesting device 100. The feed module 120 includes a drive mechanism including a first drive roller 122 and a second drive roller 124, which collectively engage and pull portions of a plant (e.g., stem/branch) through the feed plate 130. That is, a user may manually feed a portion of a plant (e.g., the cut end of a stem of a harvested plant) through the front plate 130, where the, for example, stem is captured between the first drive roller 122 and the second drive roller 124. Rotation of the first drive roller by the motor 114 (e.g., through flexible coupling 116) in the clock-wise direction 119 can cause the plant stem to become engaged (e.g., in contact with) between both the first drive roller 122 and the second drive roller 124, thereby causing the stem to move towards the back of the opposite/back side of the feed module 120. In some embodiments, the offset between the first drive roller 122 and the second drive roller 124 may be adjustable. For instance, for larger plant stalks, a spacing or offset between the rollers may be increased. Likewise, for smaller stalks, the offset may be deceased. Most commonly, the first drive roller 122 and the second drive roller 124 contact each other (FIG. 2B), and thereby rotation of the first drive roller 122 by motor 114 causes the second drive roller 124 to rotate in a counter clock-wise direction 121. Such a configuration may increase pulling force on the stem or stalk of a plant.

Embodiments of the feed module 120 include a shear mechanism 140. In the illustrated embodiment, the shear mechanism 140 is integrated with the feed plate 130. The shear mechanism 140 can be implemented in different ways, such as the iris mechanism described in U.S. patent application Ser. No. 15/711,069, which is incorporated in its entirety herein by reference. In some embodiments the shear mechanism can include a flat feed plate 130 with circular apertures or orifices there through. See, e.g., FIG. 1A, feed plate 130b. In some embodiments, the shear mechanism 140 can include a hollow tube (not shown), or set of multiple hollow tubes of the same and/or different diameters, extending from the front of feed plate 130. In this regard, the removal of plant material from a stem/branch can occur by passing the branch through the hollow center of the tube, where the diameter of the hollow center corresponds with the diameter of the stem, such that when the stem is pulled through the tube by the drive mechanism, plant material is removed from the stem by collision with the front and/or side of the tube. In some embodiments, the leading edge (i.e., the edge that contacts the plant) can be sharpened to facilitate removal of plant material from a stem/branch. That is a sharpened edge may more easily cut through the plant thereby reducing damage to portions of the plant material adjacent to the cut location.

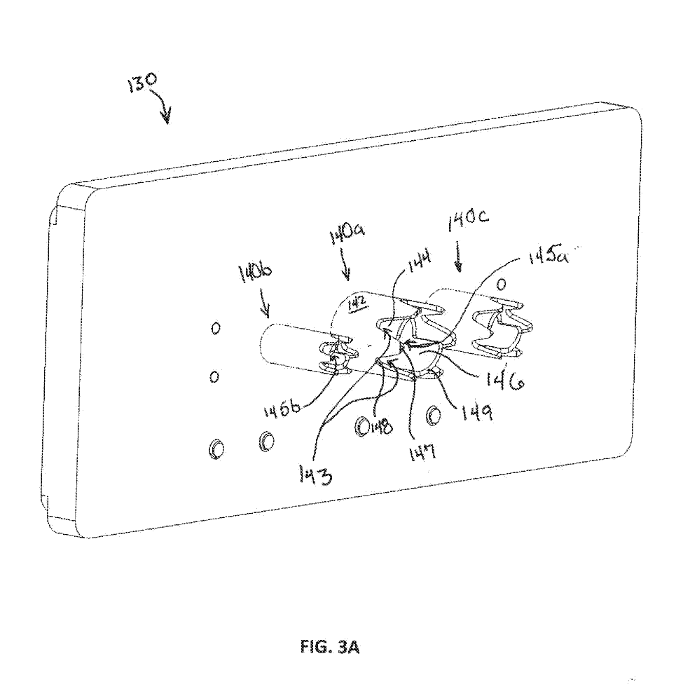

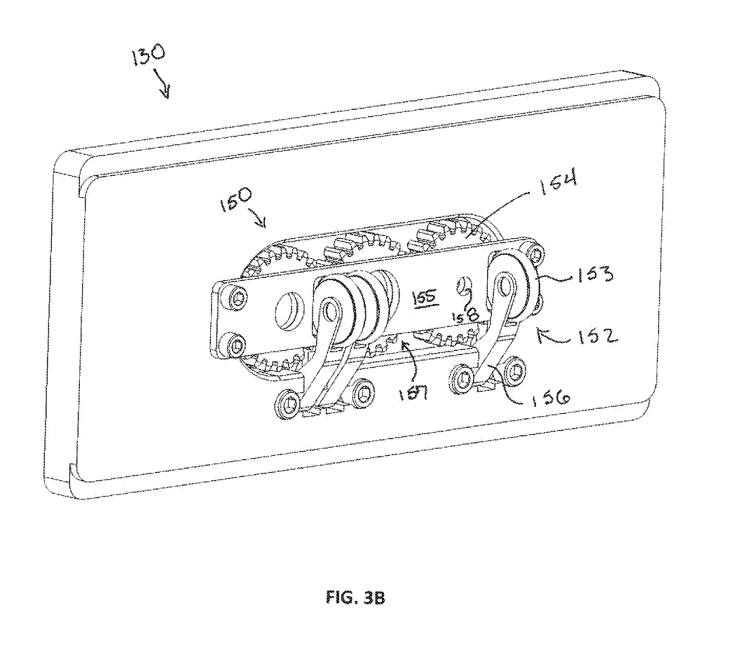

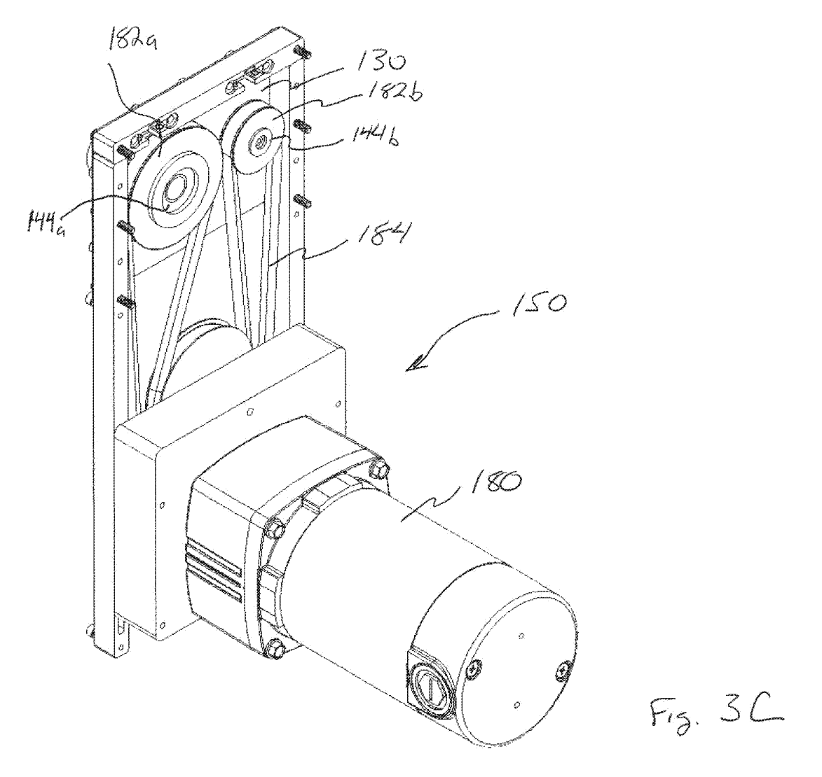

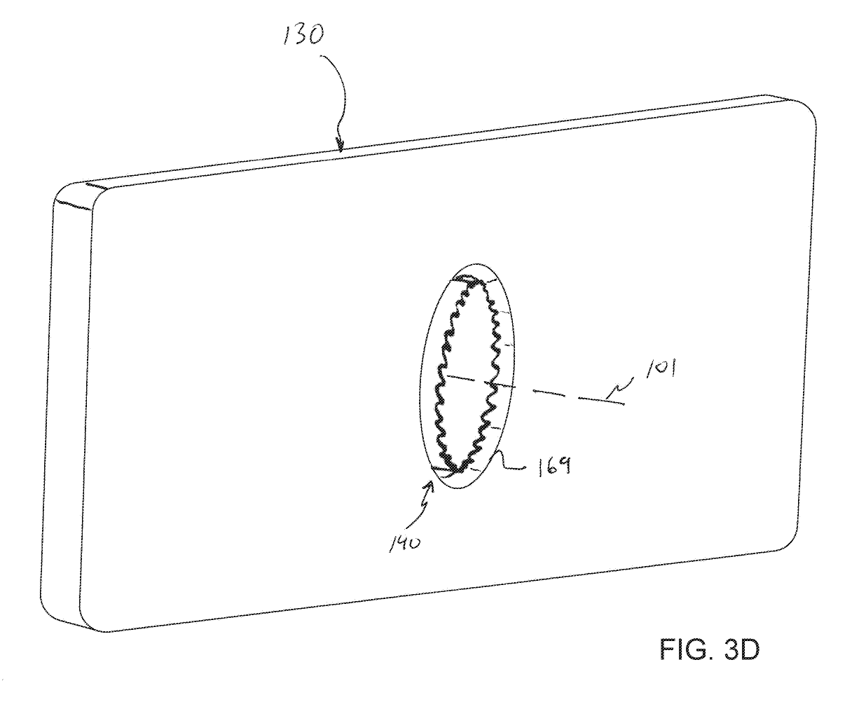

Embodiments of the shear mechanism 140 may also include dynamic or powered components. That is, components that move (e.g., rotate, oscillate, saw, and/or the like) to remove (e.g., cut, shear, etc.) plant material from a plant. Embodiments of such a dynamic shear mechanism 140 that includes an outer hub 142 and an inner cutting member 144 is illustrated in FIG. 2B. In this embodiment, the outer hub 142 is rigidly (e.g., no movement) mounted to the feed plate 130. In some embodiments, the outer hub 142 can be integrally connected to the feed plate 130 (e.g., welded, formed from a single piece of stock material, and/or the like). In other embodiments, the outer hub 142 can be removably coupled to the feed plate 130, for example, to facilitate replacement and/or maintenance. In a further embodiment, the outer hub may rotate (e.g., counter to the inner hub). In the illustrated embodiment, the outer hub 142 is a cylindrical element that includes a hollow interior in which the inner cutting member 144 is co-axially disposed. The outer hub 142 and inner cutting member 144 both include hollow interiors to permit a plant stem or stalk to pass through the shear mechanism and engage the drive rollers. The outer hub 142 extends along a central or longitudinal axis 101. The inner cutting member 144 is concentrically disposed within the outer hub 142, and also extends along the longitudinal axis 101. In this regard, the inner cutting member 144 rotates around the longitudinal axis 101 within the outer hub 144. Further, the outer hub 142 and the inner cutting member 144 form a feed aperture 145a (FIG. 3A) there through, extending along the longitudinal axis 101. In operation, a plant stem and/or branch can be inserted through the feed aperture 145a to engage with the drive mechanism. The inner cutting member 144 rotates within the outer hub 144 to shear/cut, for example, a branch from a stem as the stem is pulled through the shearing mechanism 140 by the drive mechanism. It should be noted that this shearing/cutting action can be performed on multiple different parts of a plant, for example, for removing plant material (e.g., stems, buds, leaves, etc.) from a plant stalk.

In some embodiments, rotation of the inner cutting member 144 around the longitudinal axis 101 can be driven by cutting drive 150 integrated with the feed plate 130. See, e.g., FIG. 3B. In this embodiment, the cutting drive 150 includes a power transfer wheel(s) 152 and rotational gear(s) 154 that form a power take off from the drive wheel 122. See, e.g., FIG. 2B. The power transfer wheel 152 contacts the first drive wheel 122 and a corresponding rotational gear 154. In this regard, the first drive wheel 122 rotates the power transfer wheel 152, which in turn rotates the corresponding rotational gear 154. Further, rotational gear 154 is rotationally coupled to inner cutting member 144. Therefore, the inner cutting member 144 is rotated concentrically within the outer hub 142 by power supplied from the power drive 110. However, it will be expressly understood that the cutting member 144 may be separately powered. In this regard, motors, gearing etc., completely separate from the drive wheel motors may be used. See. e.g., FIG. 3C. What is important is that the cutting member is operative to rotate.

FIGS. 3A and 3B illustrate embodiments of a feed plate 130 including multiple rotational shearing mechanisms 140a, 140b and 140c (hereafter 140 unless specifically referenced). The outer hub 142 of each shearing mechanism 140 is rigidly coupled to the feed plate 130, such that it does not move in relation to the feed plate 130. The front end of the outer hub 142 includes a plurality of tines separated by recesses 143. In some embodiments the recesses between the tines form a series of peaks and depressions in the front end of the hub. The tines and recesses can have a v-shaped profile though this is not a strict requirement. In any embodiment, the recess between the tines forms an area within the outer hub 142 that captures stems/branes of a plant while the main stalk is passing through the central aperture of the shearing mechanism and prevents the branch from freely rotating within the outer hub 142 (e.g., around the longitudinal axis). As is further discussed below, while the stem/branch is captured in the recess, it may be sheared from the main stalk of the plant. Further, as illustrated in the embodiment of FIG. 3A, the recess 143 can taper from rounded points/peaks 147 into a trough or valley 148. In this regard, a stem/branch contacting a peak 147 of the recess will be guided into valley 148 portion of a recess 143.

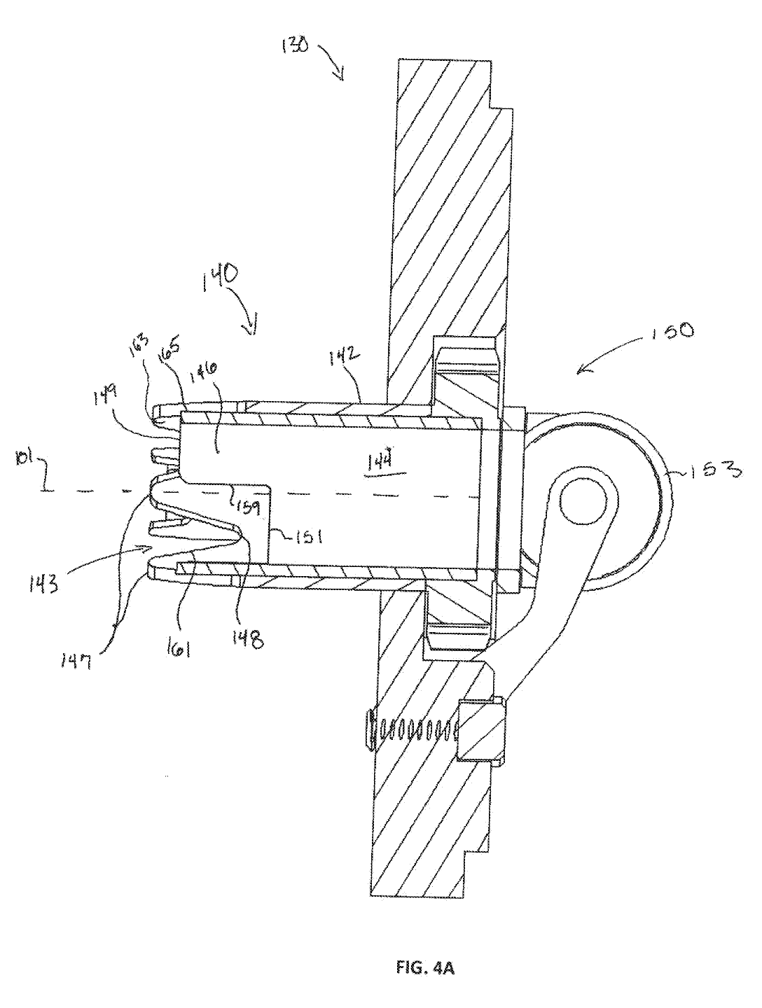

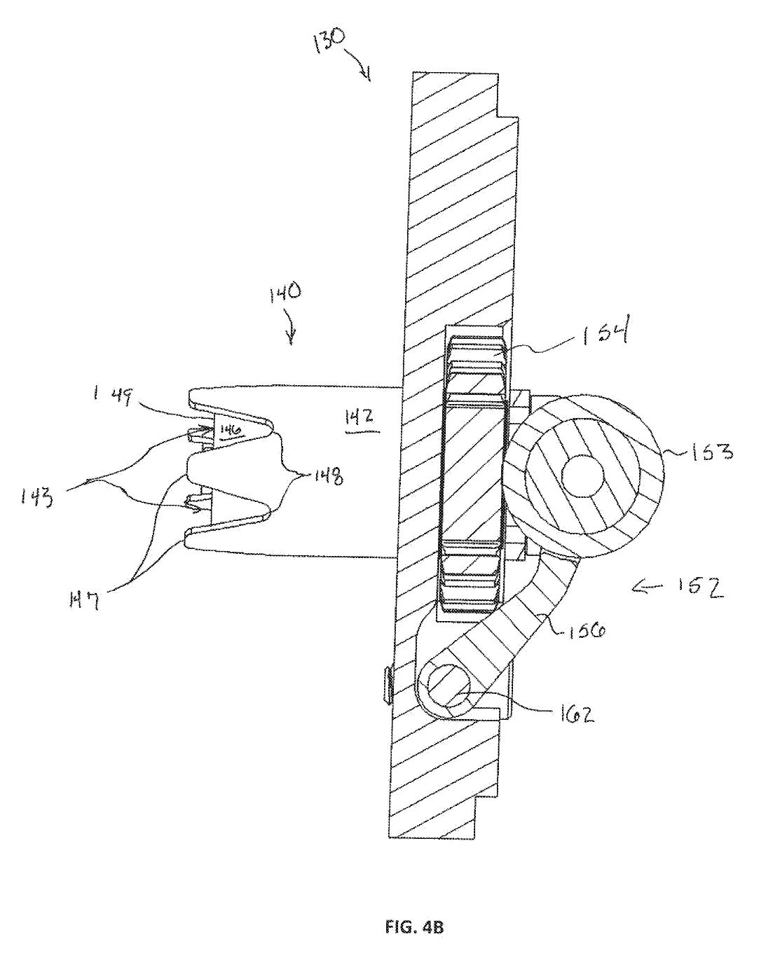

The cutting member 144 is a cylindrical body concentrically disposed within the outer hub 142. In some embodiments, the cutting member 144 further includes a shear element 146 disposed at a first end of the cutting member 144. In the illustrated embodiment, the shear element 146 is a partially cylindrical extension of the body of the cutting member 144. That is, the shear element 146 is a partially arcuate segment, which only extends around a portion of the inner circumference of the outer hub 140. The shear member 146 is configured to leave at least one recess 143 open and overlap with other recesses 143 in the outer hub 142. Therefore, in operation branches, stems and/or the like can be pulled/guided into open recesses (e.g., recesses 143 that are not currently overlapped by the shear member 146) and, as the shear member 146 is rotated around longitudinal axis 101 by the inner cutting member 144, the shearing edge 159 (shown in FIG. 4A) of the shear member 146 and the opposing edge 161 (shown on FIG. 4A) of the recess 143 will act to shear/cut the plant. As such, the rotary action of the shearing mechanism, cleanly shears the branch, plant material, and/or the like from the stem of the stalk of the plant.

Turning to FIG. 3B, an implementation of the cutting drive 150 integrated with feed plate 130 is illustrated. Notably, feed plate 130 can have a single shear mechanism 140 or multiple shear mechanisms 140a, 140b, 140c of the same and/or different sizes (e.g., different feed aperture 145a, 145b diameters). The cutting drive 150 includes power transfer wheel 152 and rotational gears 154 as discussed above. The rotational gears are coupled to the inner cutting member 144 and rotate about longitudinal axis 101. A back plate 155 can be used to dispose the rotational gears 154 within recess 157 located on the back of feed plate 130. In some embodiments the rotational gears 154 can mesh to adjacent rotational gears 154 when multiple shear mechanisms 140 are located on a single feed plate 130. Further, back plate 155 includes exit aperture 158 concentrically disposed to align with the shear mechanism 140. In this regard, plant stems/branches inserted into the feed aperture 145 can exit from the back of the feed plate 130 through exit aperture 158 to engage with the drive mechanism (e.g., first drive wheel 122 and second drive wheel 124).

Embodiments of the cutting drive 150 include one or more power transfer wheels 152 interconnected to feed plate 130. Each power transfer wheel 152 can include transfer roller 153 and mounting bracket 156. Transfer roller 153 can be configured to engage with rotational gear 154 and first drive roller 122 (see FIGS. 2A and 2B). In this regard, first drive roller 122 rotates transfer roller 153, which in turn, drives rotational gear 154. The illustrated embodiment demonstrates that the transfer of motion from first drive roller 122 to the rotational gear 154 is accomplished through frictional contact of transfer roller 153 with both the first driver roller 122 and the rotational gear 154. However, in various embodiments, the transfer roller could include other mechanisms for transferring power from first drive roller 122 to rotational gear 154 such as through a meshing of gears, pulleys and belts, chain drives, sprockets, universal joints, flexible couplings, and/or the like. Further, clutches and/or other torque limiting components can be used to prevent damage to components of the harvesting device 100. The mounting bracket 156 can be fixed or rotate in relation to the feed plate. That is, as the transfer roller 153 wears, the mounting bracket 156 can rotate/pivot toward the feed plate 130 to keep the transfer roller in contact with rotational gear 154.

Embodiments of cutting drive also include independent power source(s) such as an electric motor. For example, an electric motor independent from the motor 114 of the power drive 110, can be configured to rotate the cutting drive. FIG. 3C illustrates such an alternate embodiment of a cutting drive 150 integrated with a feed plate 130, which supports two shear mechanisms (not shown). In this embodiment, an electric motor 180 drives the rotation of the inner cutting members of the shear mechanisms. In the illustrated embodiment, driven pulleys 182a, 182b are rotationally coupled to the to the inner cutting members 144a, 144b of the shear mechanisms. A drive pulley on a drive shaft of the motor (neither shown) is coupled to the driven pulleys via a drive belt 184. In the illustrated embodiment, the dive belt passes from the drive pulley (not shown) around the first driven pully 182a, around an idler/tensioning pulley, around the second driven pully 182b and back to the drive pully.

Utilization of the electric motor allows for varying the rotational speed of the cutting members independent of the operation of the drive mechanism. Further, the electric motor may be a variable speed motor allowing user control of the rotational speed of the cutting elements. Yet further, the rotational speed of the cutting elements may be adjusted by changing the size of the pulleys. For instance, larger or smaller pulleys may be substituted to adjust the rotational speed of the cutting elements. In an exemplary embodiment, the electric motor 180 operates at 500 revolutions per minute (rpm). In such an embodiment, the first cutting element 144a, coupled to the larger driven pulley 182a, rotates at 550 rpm while the second cutting element 144b, coupled to the smaller driven pulley 182b, rotates at 1300 rpm. Other rotational speeds an no limitation should be inferred from this example. On some embodiment this can be an electric motor mounted to the feed plate 130. In other embodiments, this electric motor could mount to the front plate 123, interface with the cutting drive 150 to drive inner cutting member 144.

FIG. 3D illustrates an alternate embodiment of a feed plate 130 and shearing mechanism 140. In this embodiment, the inner cutting member 144 is a hollow member having a serrated forward edge similar to a hole saw utilized for construction. In this embodiment, the outer hub is omitted such that the cutting member is disposed proximate to an aperture 169 formed through the feed plate 130. The forward edge of the cutting member may be flush with the aperture, recessed relative to the aperture or extend above the aperture. Further, the cutting member may be disposed in an outer hub attached to the front surface of the plate similar to the previously discussed embodiments. In any embodiment, the cylindrical interior of the cutting member will typically be aligned with a longitudinal axis 101 that is substantially normal to the surface of the plate.

The feed plate 130, shearing mechanism 140 and cutting drive 150 can be constructed of any appropriate material(s) such as aluminum, steel, hard plastic, ceramics and/or the like. In some embodiments, various components of feed plate 130, shearing mechanism 140 and cutting drive 150 can be constructed from different materials selected based on the requirements of each individual part. One skilled in the art will realize that the material for each part can be selected based on performance requirements of individual components, pricing considerations, durability and service requirements, etc. As such, the proceeding examples are only meant to provide an illustration of how materials can be chosen for each component of the harvesting device 100 and illustrated the extensive combinations of materials (e.g., steels, plastics, ceramics, rubbers, etc.) and or drive components (e.g., gears, universal joints, clutches, etc.) that can be combined in various components (e.g., power drive 110, feed module 130, etc.) of the harvesting device 100.

FIGS. 4A and 4B illustrate side cut-away views taken at different cross-sections, respectively, of embodiments of feed plate 130. Turning first to FIG. 4A, a cross-sectional view is shown through the center of cutting mechanism 140. Cutting member 144 is concentrically disposed within outer hub 142 such that an outer surface 165 of cutting member 144 is in contact with an inner shear surface 163 of outer hub 142. In some embodiments, inner shear surface 163 of outer hub 142 can include a bushing and outer surface 165 cutting member 144 can rotate directly in contact with the outer hub 142. In some embodiments, bearing(s) can be used to dispose cutting member 144 in a fixed rotational relationship within outer hub 142. Regardless of the mechanical coupler(s) used, embodiments include positioning outer surface 165 of shear element 146 in close proximity and/or contacting the inner shear surface 163 of outer hub 142. In this regard, embodiments include offsetting the body portion of cutting member 144 from the inner surface of out hub 142, while maintain shear element 146 in contact with the inner shear surface 163 of outer hub 142. Such a configuration may reduce wear of the cutting member 144. For example, in certain embodiments it may be desirable to maintain shear element 146 in contact with at least a portion of outer hub 142 (e.g., inner surface portions between recesses 143) to create clean shear cuts through portions of a plant (e.g., stems, branches, flowers, buds, etc.) captured within a recess 143 of outer hub 142. Disposing shear element and outer hub 142 in such a configuration may reduce tearing, bruising, and/or other damage to desirable portions of a plants (e.g., flowers, buds and/or the like) that occur in traditional bucking operations.

Shear element 146 includes leading edge 149 and base edge 151 where shear element attaches to cutting member 144. Leading edge 149 is disposed between peak(s) 147 and valley(s) 148 formed by recesses 143 in outer hub 142. As shear element 146 rotates within outer hub 142, plant material within a recess 143 can be sheared/cut by shearing edge 159 of cutting element 146 and opposing edge 161 of outer hub 142. In this regard, base edge 151 can be located below (not overlapping) valley(s) 148 of outer hub 142 to allow plant material to contact the bottom of valley 148 edge. In various embodiments, shear element 146 can take on various shapes. For example, shearing edge 159 of shear element 146 can be angled in either direction to help facilitate cutting of plant material. In some embodiments, portions of shear element 146, such as shearing edge 159 and/or leading edge 149 can be sharpened. Similarly, the shape and configuration of outer hub 142 take on various shapes, sizes, etc. For example, recesses 143 can each be different shapes, have parallel or straight walls, have portions that have a first configuration and second portion that has a second configuration. For example, peak 147 can be angled to guide plant material, branches, stems, etc. into the recess 143 and the transition to a parallel or straight sided configuration, which may increase shearing force on the plant.

FIG. 4B illustrates another side cut-away view taken at a different cross-sectional location of embodiments of feed plate 130. This view further illustrates the location of shear element 146 overlapping with recess(s) 143. That is, leading edge 149 is located between peak(s) 147 and valley(s) 148. Additionally, FIG. 4B illustrate a cross-sectional view of power transfer wheel 152. Mounting bracket 156 can couple with feed plate 130 via pivot 162. As described above this can allow transfer roller 153 to move toward or way from feed plate 130, changing the contact force between the transfer wheel and rotational gear 154. Pivot 162 can be bias mounting bracket toward or away from feed plate 130. For example, pivot 162 can have a spring mechanism to bias power transfer wheel 152 in either direction. In various embodiment, pivot 162 can be passive, allowing power transfer wheel to freely rotate toward or away from feed plate 130. In this regard, first drive roller 122 can engage transfer roller 153 to create contact force between transfer roller 153 and first driver roller 122, and between transfer roller 153 and rotational gear 154.

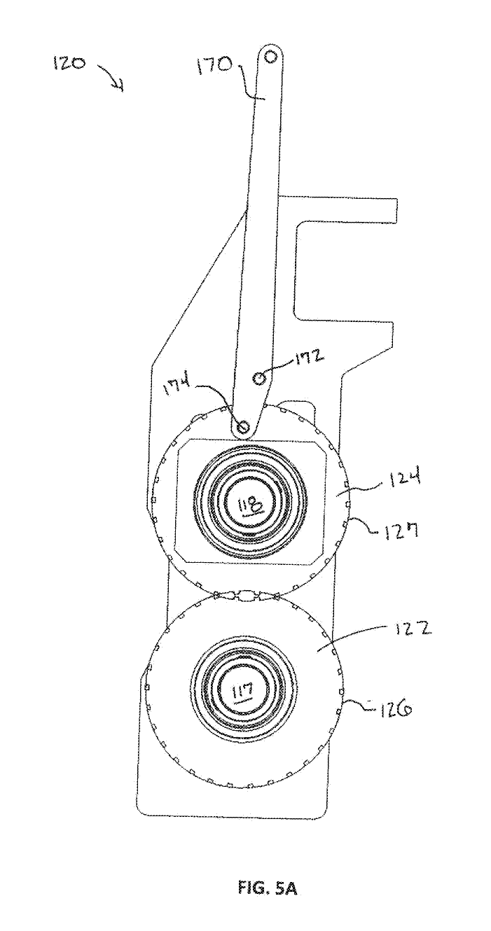

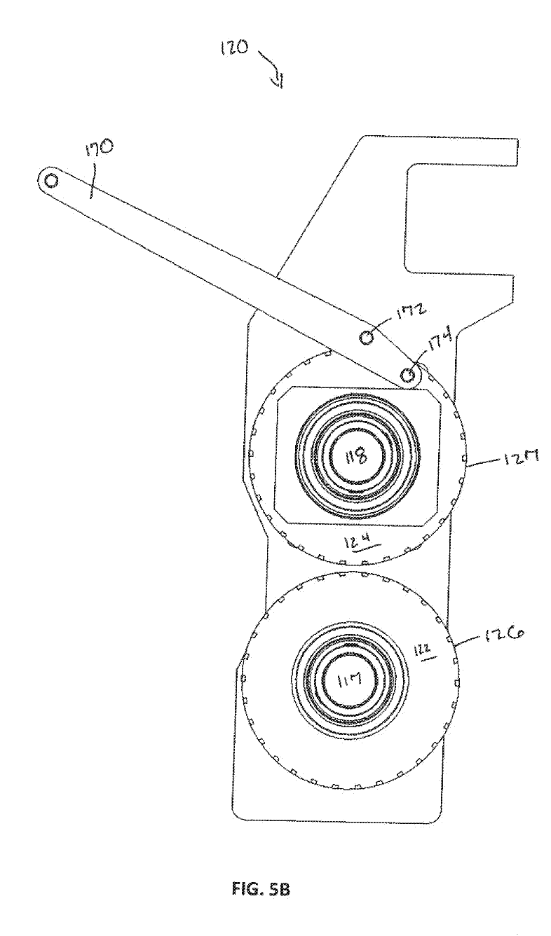

FIGS. 5A and 5B illustrate side views of embodiments of feed module 120 including lever arm 170 in various configurations. FIG. 5A illustrates lever arm in a first engaged configuration, in which first surface 126 first driver roller 122 is in contact with second surface 127 of second drive roller 124. Second drive roller 124 can be mounted on second axle 118 and freely rotate about axle 118. Further, second drive roller 124 can interconnect with lever arm 170 at lever attachment 174. Lever arm 170 can also pivotally/rotationally connect to feed module 120 at lever pivot 172. In this regard, movement of lever arm 170 causes lever attachment 174 and second feed roller 124 to pivot/move about lever pivot 172, thereby moving second drive roller 124 in relation to first drive roller 122. FIG. 5B shows lever arm 170, lever attachment 174, and second roller drive 124 in a second configuration. For example, pulling lever arm 170 downward can disengage second drive roller 124 from first drive roller 122. When actuated downward, lever arm 170 causes lever attachment to rotate about lever pivot 174 thereby moving second drive wheel 122 and second axle 118 upward. Upon losing contact with first drive roller 122, second drive roller 124 loses power and may stop rotating. In this regard, if the harvesting device 100 becomes jammed or a plant gets stuck and cannot be pulled through feed plate 130, an operator can pull lever arm 170 to disengaged second drive roller from both the plant and first drive roller 122. Then the plant may be removed from harvesting device 100. Alternatively, lever arm 170 can actuate second drive roller 124 toward first driver roller 122 to increase contact force there between. In this regard, an operator of harvesting device 100 can push on lever arm 170 to increase clamping force between the first driver roller 122 and the second drive roller 124 on, for example, a plant stem. This may aid in pulling a plant stem through feed plate 130 during processing operations.

Drive rollers 222, 224 may primarily be formed of any appropriate material. For example, plastic may be used to reduce weight, thereby reducing torque stress on motor 114. Alternatively, metal such as steel may be used to increase the service life of drive rollers 222, 224. The contact surfaces of drive rollers 222, 224 (e.g., the outer surface of the cylinder which engages a plant) may be configured for improved frictional engagement of plants. For example, as illustrated, drive rollers 222, 224 are ribbed in a direction transverse to the direction of travel of an inserted plant. In this regard, the ribs may engage the plant firmly and reduce the probability of slippage. Additionally or alternatively, drive rollers 222, 224 may comprise spikes, teeth, barbs, threads, and/or a grip coating such as rubber or adhesive, for example. As noted, displacement or separation of drive rollers 222, 224 may be mechanically controlled by lever arm 170, which counteracts the separation of drive rollers 222, 224 as a plant stem is inserted between them

In the illustrated embodiments, first drive roller(s) 122 are directly coupled to drive motors 214. However, it should be appreciated that alternative configurations are envisaged. For example, a drive motor may be affixed to a gear, the teeth of which are, in turn, engaged with teeth of a drive roller for indirect rotation of the drive roller by the drive motor. Implementations also include powering second drive roller(s) 124. This can be accomplished by interconnecting the second driver roller 124 to the power driver 110 such as through rotatory couplings used to power connect the first power drive 124. Alternatively, the power driver can include a second motor coupled to the second driver roller(s) 124.

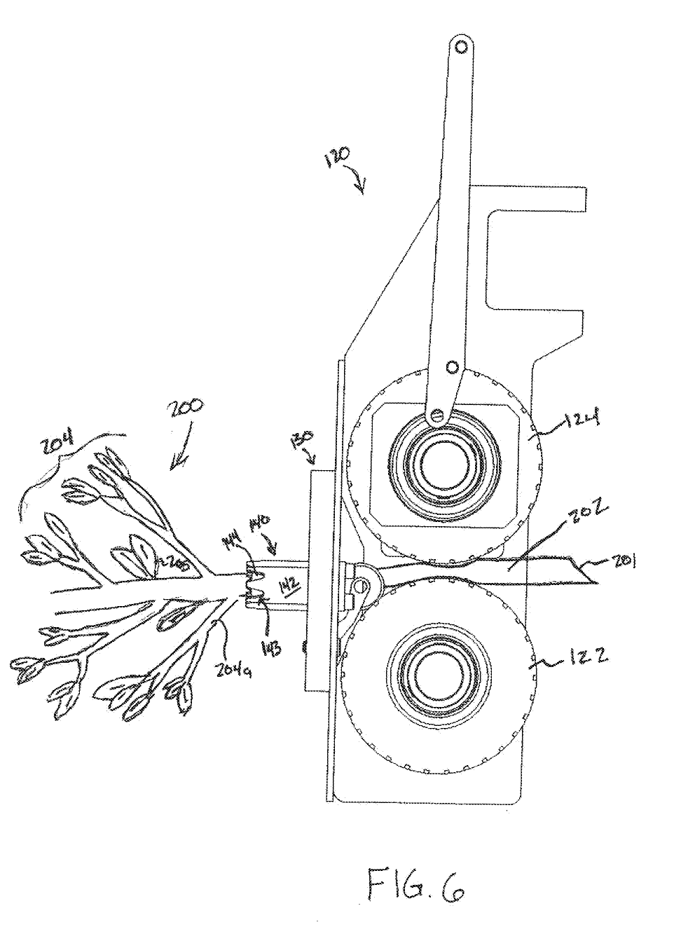

FIG. 6 illustrates a side view of embodiments of feed module 120 of harvesting device 100 processing a plant 200. When harvesting device 100 is in a resting state, motor (not shown) may be de-energized or may be operating at an idle speed. The cut end 201 of a stem 202 of a plant 200 may be inserted through feed aperture 145 of feed plate 130. The stem 202 may pass through the shearing mechanism 140 of and contact one or both drive rollers 122, 124. Engagement of the drive rollers 122, 124 with the stem 202 pulls the branches 204 toward the shearing mechanism 140. Branch 204a, for example, is guided into recess 143 of the outer hub 142. Cutting member 144 is driven by the motor (not shown) through first driver roller 122 and rotates concentrically within outer hub 142. When branch 204a is positioned within recess 143 the rotation of cutting member 144 shears branch 204a from stem 202. Notably, shearing occurs in a radially direction relative to longitudinal axis 101. In this regard, plant material, branches and/or stems are sheared/cut by cutting member 144 transverse to the direction they are being pulled by the drive mechanism. As the stem continues to be pulled into the feed module by drive rollers 122, 124 other branches 204 and/or plant material 205 (e.g., leaves, buds, etc.) are cut from stem 202. Stem 202 is discarded out the back of feed module 120, while branches 204 and plant material 205 can be collected in front of feed plate 130. In some embodiments branches with remaining plant material 205 can be run through the harvesting device again. For example, feed plate 130 can have multiple shearing mechanisms 140 of different sizes. In this regard, branches 204 removed from stem 202 during a first pass can be inserted in a second, smaller feed aperture 145 located in the same or other feed plate 130 that is connected to harvesting device 100.

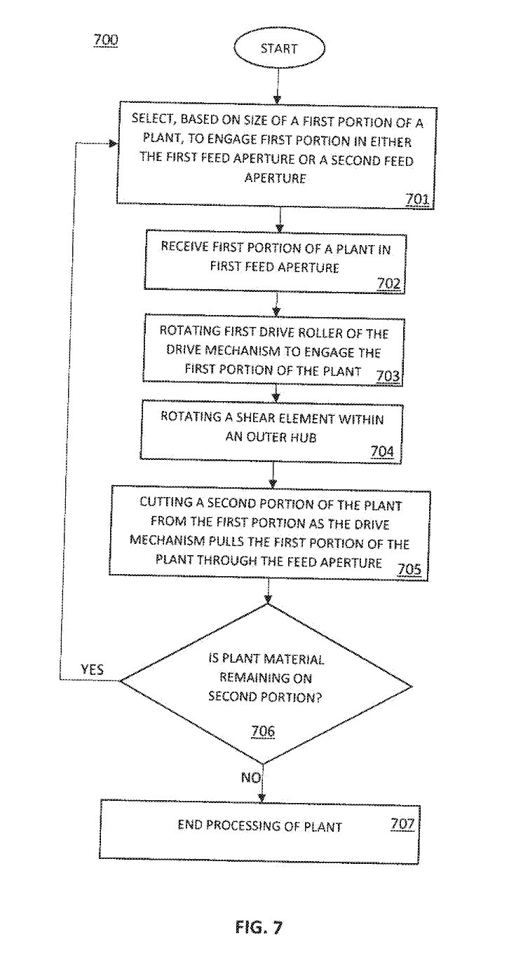

Turning to FIG. 7, a method 700 for operating a harvesting device is shown. Initially, a controller (e.g., control panel, processing engine, etc.) of the harvesting device may maintain the device in a resting configuration. In no particular order, the resting configuration may comprise operating a drive roller(s) (e.g., first driver roller 122) at a first speed, and rotating a shear element (e.g., cutting member 144) at a second speed based on a rate of rotation of drive rollers (e.g., first drive roller 122). The method 700 includes at step 701 selecting, based on a size of a first portion of a plant (e.g., stem 202), to engage the first portion of the plant in either a first feed aperture (e.g., feed aperture 145a in FIG. 3A) or a second feed aperture (e.g., feed aperture 145b in FIG. 3A). The method 700 continues at step 702 with receiving at the first portion of the plant in the first feed aperture. At 703, the method includes rotating a first drive roller of the drive mechanism to engage the first portion of the plant 202. Step 704 includes rotating a shear element (e.g., cutting element 144) within an outer hub (e.g., outer hub 142). The method continues at step 705 by cutting a second portion of the plant (e.g., branch 204) from the first portion of the plant as the drive mechanism pulls the first portion of the plant through the first feed aperture. At step 706 a determination is made as to whether there is plant material remaining on the second portion of the plant. If there is, then methods 700 starts over to process and remove additional plant material. If no plant material remains (e.g., only a stem or branch is left) then method 700 ends processing of the plant at 707.

It should also be appreciated that some of the steps illustrated in the method of FIG. 7 may be optional. For example, a resting speed may not be required. Rather, the drive rollers may be configured to operate at one speed at all times (as may be set by a user using the control panel).

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A harvesting device for separating plant material from a stem and branches of a plant, comprising:
a front plate;
a shearing mechanism disposed on the front plate comprising:
a cutting member disposed proximate to an aperture through the plate, wherein a hollow interior of the cutting member comprises a feed aperture extending along a longitudinal axis that extends substantially normal to a surface of the front plate;
a cutting drive interconnected with the cutting member, the cutting drive configured to rotate the cutting member about the longitudinal axis; and
a feed drive comprising:
a first electric motor;
a first drive roller rotationally powered by the first electric motor; and
a second drive roller, wherein the first and second drive rollers are configured to receive and engage a stem or a plant to pull the stem through the feed aperture.

2. The harvesting device of claim 1, further comprising:
an outer hub attached to the front plate, wherein the cutting member is concentrically disposed in the outer hub.

3. The harvesting device of claim 2, wherein the cutting member comprises a shear element extending from a first end.

4. The harvesting device of claim 3, wherein a front end of the outer hub comprises a series of recesses, and the shear element at least partially overlaps the series of recesses.

5. The harvesting device of claim 1, further comprising an engagement lever interconnected with the second drive roller, wherein:
in an engaged configuration the engagement lever positions a second outer surface of the second drive roller in contact with at least a portion of a first outer surface of the first drive roller; and
in a disengaged configuration the engagement lever positions the second outer surface of the second drive roller at a spaced distance from the first outer surface of the first drive roller such that the first outer surface and the second outer surface are not in contact.

6. The harvesting device of claim 1, further comprising:
a housing, wherein the housing comprises:
a plurality of walls extending from the front plate, wherein the housing forms an enclosure around at least a portion of the feed drive; and
a first implement adapter, wherein the first implement adapter removably interconnects the shearing mechanism and the cutting drive to the front plate.

7. The harvesting device of claim 6, further comprising:
a first feed plate adjoining the shearing mechanism and the cutting drive in a relative alignment; and
a second implement adapter, wherein the first implement adapter is configured to removably interconnect the first feed plate to the front plate and the second implement adapter is configured to removably interconnect a second feed plate to the front plate.

8. The harvesting device of claim 7, further comprising a second feed drive comprising:
a third drive roller rotationally powered by the first electric motor; and
a fourth drive roller, wherein the third and fourth drive rollers are configured to receive and engage a stem or a plant to pull the stem/plant through a second feed aperture associated with the second implement adapter.

9. A shearing device for separating plant leaves and buds from stems and branches of a plant, the shearing device comprising:
an outer hub comprising:
at least one recess located in a first end of the outer hub; and
an inner shear surface;
an inner cutting member comprising:
a shearing element;
an outer surface; and
a feed aperture extending along a longitudinal axis of the inner cutting member, wherein the inner cutting member is concentrically disposed within the outer hub such that the shearing element at least partially extends past the at least one recess;
a cutting drive mechanism interconnected to the inner cutting member and configured to rotate the inner cutting member within the outer hub; and
a feed plate interconnecting the outer hub, the inner cutting member and the cutting drive mechanism in a relative orientation to each other.

10. The shearing device of claim 9, wherein the shearing element comprises an arcuate segment radially extending around a longitudinal axis of the inner annular member.

11. The shearing device of claim 10, wherein the inner cutting member is disposed within the outer hub such that a front end of the shearing element is located between the first end and a bottom edge of the at least one recess.

12. The shearing device of claim 9, further comprising:
a housing comprising:
a first drive motor; and
a first drive roller rotationally powered by the first drive motor; and
wherein the housing removable interconnects to the mounting plate such that the rotary drive mechanism is powered by the first drive roller.

13. The shearing device of claim 12, wherein the rotary drive mechanism further comprises a drive wheel engaging the first drive roller, wherein the drive wheel transfers rotary power from the drive wheel to the inner annular member.

14. The shearing device of claim 9, wherein the at least one recess comprises a sinusoidal sequences forming a series of peaks and depressions along the first end.

15. The shearing device of claim 14, wherein the peaks of the sequences of peaks and depressions are non-planar and configured to guide plant stems and branches into at least one depression of the series of peaks and depressions.

16. The shearing device of claim 9, wherein an outer surface of the shear element abuts the inner shear surface of the outer hub.

17. A method of removing plant material from a stem and branches of a plant, the method comprising:
receiving a first portion of a plant in a first feed drive of a harvesting device;
first rotating a first drive roller of a drive mechanism to engage the first portion of the plant and pull the plant through the harvesting device; and
second rotating a first cutting member within a first outer hub to cut a second portion of the plant from the first portion of the plant as the drive mechanism pulls the first portion of the plant through a first feed aperture in the first outer hub.

18. The method of claim 17, wherein the first outer hub has at least a first peak and a first depression, and the second portion of the plant is cut from the first portion of the plant within the first depression of the outer hub.

19. The method of claim 17, further comprising:
providing a second cutting member within a second outer hub spaced from said first outer hub, wherein a second aperture in the second outer hub is larger than the first aperture; and
selecting, based on a size of the first portion of the plant, to engage the first portion of the plant in either the first aperture or the second aperture such that the plant is received in the drive mechanism of the harvesting device.

20. The method of claim 17, wherein a speed of the second rotating is selected based on a rate of rotation of the first drive roller.
